(19) United States
(12) Patent Application Publication
(10) Pub. No.: US 2026/0067717 A1
(43) Pub. Date: Mar. 5, 2026

(54) METHODS FOR IMPROVING UE BEAM PREDICTION PROCEDURES BASED ON BEAM IDENTIFIERS

(71) Applicant: Telefonaktiebolaget LM Ericsson (publ), Stockholm (SE)

(72) Inventors: Henrik RYDÉN, Stockholm (SE); Andreas NILSSON, Göteborg (SE); Roy TIMO, Kungsängen (SE)

(21) Appl. No.: 19/101,621

(22) PCT Filed: Aug. 11, 2023
(86) PCT No.: PCT/SE2023/050809

§ 371 Date: Feb. 6, 2025

Related U.S. Application Data
(60) Provisional application No. 63/397,672, filed on Aug. 12, 2022.

(51) Int. Cl. H04W 24/02; H04W 24/08

(52) U.S. Cl. CPC H04W 24/02; H04W 24/08

(57) ABSTRACT

A wireless device (WD) is described. The WD is configured to communicate with a network node and to determine one or more beam identifiers (IDs) one or both of are not included in training data of the artificial intelligence model and have not been used for training an artificial intelligence model. If the one or more beam IDs one or both of are not included in the training data of the artificial intelligence model and have not been used for training the artificial intelligence model, a first request is transmitted to the network node requesting assistance information associated with the one or more beam IDs and/or the assistance information is received. In addition, the WD is configured to cause the artificial intelligence model to be trained using the received assistance information and perform one or more actions using the artificial intelligence model.

### TECHNICAL FIELD

The present disclosure relates to wireless communications, and in particular, to wireless beam prediction using assistance information.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

One of the features of NR, compared to previous generation of wireless networks, is the ability to operate in higher frequencies (e.g., above 10 GHz). The available large transmission bandwidths in these frequency ranges can potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both receiver and transmitter sides—are needed to create such highly direction beams.

Antenna arrays for high frequencies may use time-domain analog beamforming, e.g., to reduce hardware costs. A core idea of analog beamforming is to share a single radio frequency chain between many (or, potentially, all) of the antenna elements. A limitation of analog beamforming is that it is only possible to transmit radio energy in using one beam (in one direction) at a given time.

The above limitation requires the network node (NN) and WD to preform beam management procedures to establish and maintain suitable transmitter (Tx)/receiver (Rx) beam-pairs. For example, beam management procedures can be used by a transmitter to sweep a geographic area by transmitting reference signals on different candidate beams, during non-overlapping time intervals, using a predetermined pattern. Further, by measuring the quality of this reference signals at the receiver side, the best transmit and receive beams can be identified.

### NR Beam Management Procedures

Beam management procedures in NR may defined by a set of L1/L2 procedures (i.e., Open Systems Interconnection Layer 1 (also known as the physical layer) and/or Layer 2 (also known as the medium access control layer) procedures) that establish and maintain a suitable beam pairs for both transmitting and receiving data. A beam management procedure can include one or more sub procedures such as beam determination, beam measurements, beam reporting, and beam sweeping.

In cases of downlink transmission from the NN to the WD, P1/P2/P3 beam management procedures (defined below) can be performed, e.g., according to NR study item (SI) technical reports (TRs) such as 3GPP TR 38.802, V14.2.0, etc. P1/P2/P3 beam management procedures may be performed to overcome the challenges of establishing and maintaining the beam pairs when, for example, a WD moves or some blockage in the environment requires changing the beams. Although these scenarios are not directly mentioned in specifications of 3GPP, there are relevant procedures defined which may enable the realization of these scenarios.
P1: The P1 procedure may be used to enable WD measurement on different transmission/reception point (TRP) Tx beams to support selection of TRP Tx beams/WD Rx beam(s). During initial access, for example, the network node (e.g., gNB) transmits SS/PBCH block (SSB) beams in different directions to cover the whole cell. The WD may measures signal quality on corresponding SSB signals to detect and select an appropriate SSB beam. FIG. 1 shows an example SSB beam selection as part of initial access procedure according to a P1 scenario. Random access may then be transmitted on random access channel (RACH) resources indicated by a selected synchronization signal block (SSB). The corresponding beam may be used by both the WD and the network node to communicate until connected mode beam management is active. The network node may infer which SSB beam was chosen by the WD without any explicit signaling.
   For beamforming at TRP, an intra/inter-TRP Tx beam sweep from a set of different beams is typically included. For beamforming at WD, a WD Rx beam sweep from a set of different beams is typically included.
P2: The P2 procedure may be used to enable WD measurement on different TRP Tx beams to possibly change inter/intra-TRP Tx beam(s). The network node may use the SSB beam as an indication of which (narrow) channel state information reference signal (CSI-RS) beams to try. That is, the selected SSB beam can be used to define a candidate set of narrow CSI-RS beams for beam management. Once CSI-RS is transmitted, the WD may measure the Reference Signal Received Power (RSRP) and report the result to the network. If the network receives a CSI-RSRP report from the WD where a new CSI-RS beam is better than the old used to transmit physical downlink control channel (PDCCH) and/or physical downlink shared channel (PDSCH), the network may update the serving beam for the WD accordingly and/or modify the candidate set of CSI-RS beams. The network node can also instruct the WD to perform measurements on SSBs. If the network receives a report from the WD where a new SSB beam is better than the previous best SSB beam, a corresponding update of the candidate set of CSI-RS beams for the WD may be motivated.
   P2 procedure may be performed on a possibly smaller set of beams for beam refinement than in P1. Note that P2 can be a special case of P1. For example, in connected mode, the network node (e.g., gNB) may configure the WD with different CSI-RSs and transmit each CSI-RS on a corresponding beam. WD may then measure the quality of each CSI-RS beam on its current RX beam and send feedback about the quality of the measured beams. Thereafter, based on this feedback, the network node (e.g., gNB) may decide and/or indicate to the WD which beam will be used in future transmissions. This is shown in FIG. 2.
P3: may be used to enable WD measurement on the same TRP Tx beam to change WD Rx beam in the case WD uses beamforming. Once in connected mode, the WD may be configured with a set of reference signals. Based on measurements, the WD may determine which Rx beam is suitable to receive each reference signal in the set. The network node may then indicate which reference signals are associated with the beam that may be used to transmit PDCCHPDSCH, and the WD may this information to adjust its Rx beam when receiving PDCCH/PDSCH. FIG. 3 shows an example of WD Rx beam selection for a corresponding CSI-RS Tx beam in downlink according to a P3 scenario.
   In connected mode, P3 may be used by the WD to find the best Rx beam for corresponding Tx beam. In this case the network node (e.g., gNB) keeps one CSI-RS Tx beam at a time, and WD m ay perform the sweeping and measurements on its own Rx beams for that specific Tx beam. The WD may then find the best corresponding Rx beam based on the measurements and will use it in future for reception when the network node (e.g., gNB) indicates the use of that Tx beam.

### Beam Measurement and Reporting in NR

For beam management, a WD can be configured to report RSRP or/and Signal to Interference and Noise Ratio (SINR) for each one of up to four beams, either on CSI-RS or SSB. WD measurement reports can be sent either over PUCCH or PUSCH to the network node, e.g., gNB.

### Reference Signal Configurations in NR

### CSI-RS:

A CSI-RS may be transmitted over each transmit (Tx) antenna port at the network node and for different antenna ports. The CSI-RS may be multiplexed in time, frequency, and code domain such that the channel between each Tx antenna port at the network node and each receive antenna port at a WD can be measured by the WD. The time-frequency resource used for transmitting CSI-RS may be referred to as a CSI-RS resource.

In NR, the CSI-RS for beam management may be defined as a 1- or 2-port CSI-RS resource in a CSI-RS resource set where the filed repetition is present. The following three example types of CSI-RS transmissions are supported:
Periodic CSI-RS: CSI-RS is transmitted periodically in certain slots. This CSI-RS transmission is semi-statically configured using RRC signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling may be needed to activate and deactivate the CSI-RS transmission.
Aperiodic CSI-RS: This is a one-shot CSI-RS transmission that can happen in any slot. Here, one-shot means that CSI-RS transmission may only happens once per trigger. The CSI-RS resources (i.e., the RE locations which consist of subcarrier locations and OFDM symbol locations) for aperiodic CSI-RS may be semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources may be included in a CSI-RS resource set, and the triggering of aperiodic CSI-RS may be on a resource set basis.

### SSB:

In NR, an SSB may include a pair of synchronization signals (SSs), physical broadcast channel (PBCH), and demodulation reference signal (DMRS) for PBCH. An SSB is mapped to four consecutive orthogonal frequency-division multiplexing (OFDM) symbols in the time domain and 240 contiguous subcarriers (20 RBs) in the frequency domain.

NR supports beamforming and beam-sweeping for SSB transmission, by enabling a cell to transmit multiple SSBs in different narrow-beams multiplexed in time. The transmission of these SSBs may be confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame may be broadcasted periodically from each cell. The periodicity of the half frames with SS/PBCH blocks may be referred to as SSB periodicity, which may be indicated by SIB1.

The maximum number of SSBs within a half frame, denoted by L, may depend on the frequency band, and the time locations for these L candidate SSBs within a half frame may depend on the subcarrier spacing (SCS) of the SSBs. The L candidate SSBs within a half frame may be indexed in an ascending order in time from 0 to L−1. By successfully detecting PBCH and its associated DMRS, a WD may know the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

### Measurement Resource Configurations in NR

A WD can be configured with the following:
N≥1 CSI reporting settings (CSI-ReportConfig); and/or
M≥1 resource settings (CSI-ResourceConfig).

Each CSI reporting setting may be linked to one or more resource settings for channel and/or interference measurement. The CSI framework may be modular in the sense that several CSI reporting settings may be associated with the same Resource Setting.

The measurement resource configurations for beam management may be provided to the WD by radio resource control (RRC) information element (IE) (CSI-ResourceConfigs). One CSI-ResourceConfig contains several non-zero power (NZP)-CSI-RS-ResourceSets and/or CSI-SSB-ResourceSets.

A WD may be configured to measure CSI-RSs using the RRC IE NZP-CSI-RS-ResourceSet. A NZP CSI-RS resource set contains the configurations of Ks≥1 CSI-RS resources. Each CSI-RS resource configuration resource includes at least the following:
mapping to REs,
the number of antenna ports, and
time-domain behavior.

Up to 64 CSI-RS resources can be grouped together in an NZP-CSI-RS-ResourceSet.

A WD can be configured to measure SSBs using the RRC IE CSI-SSB-ResourceSet. Resource sets comprising SSB resources may be defined in a similar manner to the CSI-RS resources defined above.

In the case of aperiodic CSI-RS and/or aperiodic CSI reporting, the network node may configure the WD with S_c CSI triggering states. Each triggering state may include the aperiodic CSI report setting to be triggered along with the associated aperiodic CSI-RS resource sets.

Periodic and semi-persistent resource settings may only comprise a single resource set (i.e., S=1). Aperiodic resource settings can have many resources sets (S>=1), e.g., because one out of the S resource sets defined in the resource setting is indicated by the aperiodic triggering state that triggers a CSI report.

### Measurement Reporting

Three types of CSI reporting may be supported in NR:
Periodic CSI Reporting on PUCCH: CSI may be reported periodically by a WD. Parameters such as periodicity and slot offset may be configured semi-statically by higher layer RRC signaling from the network node to the WD
Semi-Persistent CSI Reporting on PUSCH or PUCCH: similar to periodic CSI reporting, semi-persistent CSI reporting has a periodicity and slot offset which may be semi-statically configured. However, a dynamic trigger from network node to WD may be needed to allow the WD to begin semi-persistent CSI reporting. A dynamic trigger from network node to WD is needed to request the WD to stop the semi-persistent CSI reporting.
Aperiodic CSI Reporting on PUSCH: This type of CSI reporting involves a single-shot (i.e., one time) CSI report by a WD which may be dynamically triggered by the network node using DCI. Some of the parameters related to the configuration of the aperiodic CSI report is semi-statically configured by RRC but the triggering is dynamic

In each CSI reporting setting, the content and time-domain behavior of the report may be defined, along with the linkage to the associated Resource Settings.

The CSI-ReportConfig 1E comprise the following configurations:
reportConfigType
   Defines the time-domain behavior (periodic CSI reporting, semi-persistent CSI reporting, or aperiodic CSI reporting) along with the periodicity and slot offset of the report for periodic CSI reporting.
reportQuantity
   Defines the reported CSI parameters—the CSI content; for example, the precoding matrix index (PMI), channel quality indication (CQI), resource indicator (RI), layer indicator (LI), CSI-RS resource index (CRI) and L1-RSRP. Only certain combinations are possible; for example, ‘cri-RI-PMI-CQI’ may be one possible value and ‘cri-RSRP’ is another) and each value of reportQuantity may correspond to a certain CSI mode.
codebookConfig
   Defines the codebook used for PMI reporting, along with possible codebook subset restriction (CBSR). NR supported the following two types of PMI codebooks: Type I CSI and Type II CSI. Additionally, the Type I and Type II codebooks each may be two different variants: regular and port selection.
reportFrequencyConfiguration
   Defines the frequency granularity of PMI and CQI (wideband or subband), if reported, along with the CSI reporting band, which is a subset of subbands of the bandwidth part (BWP) which the CSI corresponds to.
Measurement restriction in time domain (ON/OFF) for channel and interference respectively

For beam management, a WD can be configured to report L1-RSRP for up to four different CSI-RS/SSB resource indicators. The reported RSRP value corresponding to the first (best) CRI and/or SSB RI (SSBRI) requires 7 bits, using absolute values, while the others require 4 bits using encoding relative to the first. In NR release 16, the report of L1-SINR for beam management has already been supported.

### 3GPP Considerations

The 3GPP has decided to study artificial intelligence and/or machine learning (AI/ML) based spatial beam prediction, the core idea of which is as follows: Predict the “best” beam (or beams) from a Set A of beams using measurement results from another Set B of beams.

Set A and Set B of beams have not been defined yet (left for future study). However, the following two examples illustrate some scenarios that may be studied in 3GPP Release 18:
Set B is a subset of a Set A. For example, Set A is a set of 8 SSB/CSI-RS beams shown in FIG. 4 (both light and dark circles). More specifically, FIG. 4 shows an example where Set B is a subset of Set A. A grid-of-beam type radiation pattern is shown: Each row (resp. column) depicts a certain zenith (resp. azimuth) angle from the antenna array. Set A has 8 beams and Set B has 4 beams (indicated by dark circles). The WD measures Set B (the 4 beams indicated by dark circles). The AI/ML model should predict the best beam (or beams) in Set A using only measurements from Set B.
Set A and Set B may correspond to two different sets of beams. For example, Set A may be a set of 30 narrow CSI-RS beams, and Set B may be a set of 8 wide SSB beams. The WD may measure beams in Set B and the AI/ML model may predict the best beam(s) from Set A. FIG. 5 shows an example of a Set A that is a set of narrow beams and a Set B that is a set of wide beams.

The spatial beam prediction may be performed in the network node (e.g., gNB) and/or the WD-a study item may cover both scenarios. The prediction may be based on L1-RSRP estimates for each beam. A study item may, however, also include additional assistance information to help AI/ML model training and inference. For example, a network node may provide beam-shape assistance information (e.g., Tx beam shapes) to the WD. Beam-shape information may enable the WD to collect and label beam management data (e.g., L1-RSRPs) for the purpose of designing, training, and deploying spatial/temporal beam prediction AI/ML models to WDs.

The following list summarizes different types of assistance information proposed within the 3GPP:
Tx and/or Rx beam shape information (e.g., Tx and/or Rx beam pattern, Tx and/or Rx beam boresight direction (azimuth and zenith angles from the array), 3 dB beamwidth, etc.),
expected Tx and/or Rx beam for the prediction (e.g., expected Tx and/or Rx angle, Tx and/or Rx beam ID for the prediction),
WD position information,
WD direction information,
Tx beam usage information,
WD orientation information.

We note that providing Tx and/or Rx beam shape and/or angles as assistance information for training AI/ML models may be problematic. For example, sharing such information may leak information about proprietary beamforming solutions and compromise performance differentiations between different vendors. Moreover, such information may not always be well defined: A “beam” cannot always be described using a beam boresight direction and beam width. Indeed, NR specifications do not explicitly define “beams” for beam management, and, instead, use the TCI framework to enable the P1/P2/P3 procedures.

Further, a network node may indicate a beam configuration identifier or beam ID to the WD. In other words, the network node may associate different SSB/CSI-RS beams with different beam IDs. The network node may share the beam IDs with the WD whenever the WD needs to know how the SSB/CSI-RS is beamformed. The WD does not know how the SSB/CSI-RS is beamformed but may assume that any two reference signals with the same beam ID have been beamformed in the same way.

A basic problem beam ID assistance information may be as follows. The network node may dynamically update beamforming weights for SSB and/or CSI-RS to, for example, adapt to changing propagation conditions and/or traffic loads. The WD, however, is only provided with beam ID assistance information; the WD is not provided any explicit information (e.g., beam widths and/or pointing angles) about how the SSB and/or CSI-RS is beamformed. If SSB/CSI-RS beamforming weights are dynamically updated, then it is not clear how they can be reliably connected to semi-static beam IDs.

For example, it could be left for the network implementation to determine which beam ID is to be signaled to the WD and/or whether new beam IDs are required. This situation is problematic because the network node cannot know how data is collected, labeled, and used for training/retraining WD-side AI/ML models. Indeed, the number of beam IDs will grow rapidly if the network node allocates a new ID for every SSB/CSI-RS beamforming weight update-leading to unnecessarily large control overhead and difficulties for WD-side data collection and AI/ML model training/retraining.

### SUMMARY

Some embodiments advantageously provide methods, systems, and apparatuses for performing beam prediction procedures (e.g., WD beam prediction procedures) such as based on beam IDs. In some embodiments, when a WD encounters a new beam ID (e.g., a beam ID for which it has not collected data and/or trained AI/ML models), the WD may request additional assistance information from the network node. In some other embodiments, the additional assistance information indicates to the WD how the new beam ID relates to existing beam IDs for which it already has data and trained AI/ML models. In on embodiment, the network node may associate unique beam IDs to different SSB/CSI-RS beams. The WD may be configured to use the beam IDs to collect measurement data for training/retraining AI/ML models. Further, if the network node dynamically updates its SSB/CSI-RS precoding weights, the network node may associate a new beam ID with the new precoding weights.

In one or more embodiments, the network node may be configured to assist the WD to train models (e.g., new models), or update other models (e.g., existing models), e.g., after network changes. Further, the present disclosure describes embodiments that are useful in dynamic scenarios, where the evolving nature of the scenario can motivate a change of beamforming configurations, at the network node. Further, overhead in data collection and training models at the device may be reduced when compared to typical system.

According to one aspect, a wireless device (WD) is described. The WD is configured to communicate with a network node and predict, using an artificial intelligence model, a first set of beams by measuring a second set of beams. Further, the WD is configured to determine one or more beam identifiers (IDs) one or both of are not included in training data of the artificial intelligence model and have not been used for training the artificial intelligence model. The WD is also configured to, if the one or more beam IDs one or both of are not included in the training data of the artificial intelligence model and have not been used for training the artificial intelligence model, transmit a first request, to the network node, requesting assistance information associated with the one or more beam IDs and receive the assistance information. In addition, the WD is configured to cause the artificial intelligence model to be trained using the received assistance information and perform one or more actions using the artificial intelligence model that is trained using the received assistance information.

In some embodiments, the WD is further configured to receive, from the network node, a first set of beam IDs corresponding to the first set of beams and a second set of beam IDs corresponding to the second set of beams. The one or more beam IDs being included in one or both of the first set of beam IDs and the second set of beam IDs.

In some other embodiments, each beam ID of one or both of the first set of beam IDs and the second set of beam IDs is associated with a downlink reference signal ID (DL-RS ID). The DL-RS ID includes one or more of: (A) one or both of a channel state information reference signal, CSI-RS, resource index and a CSI-RS resource set ID; and (B) one or both of a synchronization signal block resource indicator (SSBRI) and an SSB resource set ID.

In some embodiments, one or both of the first request includes the one or more beam IDs and the first request requests to one or more of be configured with the one or more beams a predetermined configuration frequency, receive correlations to other beams, and receive the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the WD is further configured to one or more of transmit a second request for a beam ID configuration, receive an indication indicating at least the one or more beam IDs, and determine whether the artificial intelligence model is valid for the one or more beam IDs.

In some embodiments, one or both of: (A) causing the artificial intelligence model to be trained using the received assistance information includes one or more of: (a) the WD training the artificial intelligence model; (b) the WD transmitting signaling to one or both of the network node and a cloud-based network node, where the signaling includes information about how to train the artificial intelligence model; (c) the WD including the received assistance information in the information about how to train the artificial intelligence model; (d) the network node training the artificial intelligence model and transmitting the trained artificial intelligence model to the WD; (e) causing the cloud-based network node to train the artificial intelligence model and to transmit the trained artificial intelligence model to the WD; and (B) performing the one or more actions includes one or more of: (a) predicting the first set of beams by measuring the second set of beams using the artificial intelligence model that is trained using the received assistance information; (b) transmitting, to the network node, a third request requesting additional assistance information for a third set of beam IDs, the third set of beam IDs being part of the training data; (c) receiving, from the network node, the additional assistance information; and (d) deleting information related to the third set of beam IDs.

According to another aspect, a method in a wireless device (WD) is described. The WD is configured to communicate with a network node and predict, using an artificial intelligence model, a first set of beams by measuring a second set of beams. The method includes determining one or more beam identifiers (IDs) one or both of are not included in training data of the artificial intelligence model and have not been used for training the artificial intelligence model. The method also includes, if the one or more beam IDs one or both of are not included in the training data of the artificial intelligence model and have not been used for training the artificial intelligence model, transmitting a first request, to the network node, requesting assistance information associated with the one or more beam IDs and receiving the assistance information. In addition, the method includes causing the artificial intelligence model to be trained using the received assistance information and perform one or more actions using the artificial intelligence model that is trained using the received assistance information.

In some embodiments, the method further includes receiving, from the network node, a first set of beam IDs corresponding to the first set of beams and a second set of beam IDs corresponding to the second set of beams. The one or more beam IDs being included in one or both of the first set of beam IDs and the second set of beam IDs.

In some other embodiments, each beam ID of one or both of the first set of beam IDs and the second set of beam IDs is associated with a downlink reference signal ID (DL-RS ID). The DL-RS ID includes one or more of: (A) one or both of a channel state information reference signal, CSI-RS, resource index and a CSI-RS resource set ID; and (B) one or both of a synchronization signal block resource indicator (SSBRI) and an SSB resource set ID.

In some embodiments, one or both of the first request includes the one or more beam IDs and the first request requests to one or more of be configured with the one or more beams a predetermined configuration frequency, receive correlations to other beams, and receive the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the method further includes one or more of transmitting a second request for a beam ID configuration, receiving an indication indicating at least the one or more beam IDs, and determining whether the artificial intelligence model is valid for the one or more beam IDs.

In some embodiments, one or both of: (A) causing the artificial intelligence model to be trained using the received assistance information includes one or more of: (a) the WD training the artificial intelligence model; (b) the WD transmitting signaling to one or both of the network node and a cloud-based network node, where the signaling includes information about how to train the artificial intelligence model; (c) the WD including the received assistance information in the information about how to train the artificial intelligence model; (d) the network node training the artificial intelligence model and transmitting the trained artificial intelligence model to the WD; (e) causing the cloud-based network node to train the artificial intelligence model and to transmit the trained artificial intelligence model to the WD; and (B) performing the one or more actions includes one or more of: (a) predicting the first set of beams by measuring the second set of beams using the artificial intelligence model that is trained using the received assistance information; (b) transmitting, to the network node, a third request requesting additional assistance information for a third set of beam IDs, the third set of beam IDs being part of the training data; (c) receiving, from the network node, the additional assistance information; and (d) deleting information related to the third set of beam IDs.

According to one aspect, a network node is described. The network node is configured to communicate with a wireless device (WD) and to provide assistance information usable to predict, using an artificial intelligence model, a first set of beams by measuring a second set of beams. The network node is further configured to receive a first request, from the WD, requesting assistance information associated with the one or more beam IDs if the one or more beam IDs one or both of are not included in training data of the artificial intelligence model and have not been used for training the artificial intelligence model. The assistance information is transmitted and causes the artificial intelligence model to be trained using the transmitted assistance information. Further, one or more actions are performed based on the transmitted assistance information.

In some embodiments, the network node is further configured to transmit, to the WD, a first set of beam IDs corresponding to the first set of beams and a second set of beam IDs corresponding to the second set of beams, the one or more beam IDs being included in one or both of the first set of beam IDs and the second set of beam IDs.

In some other embodiments, each beam ID of one or both of the first set of beam IDs and the second set of beam IDs is associated with a downlink reference signal ID (DL-RS ID) which includes one or more of one or both of a channel state information reference signal (CSI-RS) resource index and a CSI-RS resource set ID and one or both of a synchronization signal block resource indicator (SSBRI) and an SSB resource set ID.

In some embodiments, one or both of the first request includes the one or more beam IDs and the first request requests to one or more of the WD to be configured with the one or more beams a predetermined configuration frequency, transmit correlations to other beams, and transmit the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the network node is further configured to one or both of receive a second request for a beam ID configuration and transmit an indication indicating at least the one or more beam IDs.

In some embodiments, one or both of: (A) causing the artificial intelligence model to be trained using the transmitted assistance information includes one or more of: (a) the WD training the artificial intelligence model; (b) the WD transmitting signaling to one or both of the network node and a cloud-based network node, the signaling including information about how to train the artificial intelligence model; (c) the WD including the received assistance information in the information about how to train the artificial intelligence model; (d) the network node training the artificial intelligence model and transmitting the trained artificial intelligence model to the WD; (e) causing the cloud-based network node to train the artificial intelligence model and to transmit the trained artificial intelligence model to the WD; and (B) performing the one or more actions includes one or more of: (a) receiving, from the WD, a third request requesting additional assistance information for a third set of beam IDs, the third set of beam IDs being part of the training data; and (b) transmitting, to the WD, the additional assistance information for the WD to delete information related to the third set of beam IDs.

According to another aspect, a method in a network node is described. The network node is configured to communicate with a wireless device (WD) and to provide assistance information usable to predict, using an artificial intelligence model, a first set of beams by measuring a second set of beams. The method includes receiving a first request, from the WD, requesting assistance information associated with the one or more beam IDs if the one or more beam IDs one or both of are not included in training data of the artificial intelligence model and have not been used for training the artificial intelligence model. The method also includes transmitting the assistance information causing the artificial intelligence model to be trained using the transmitted assistance information and performing one or more actions based on the transmitted assistance information.

In some embodiments, the method further includes transmitting, to the WD, a first set of beam IDs corresponding to the first set of beams and a second set of beam IDs corresponding to the second set of beams, where the one or more beam IDs are included in one or both of the first set of beam IDs and the second set of beam IDs.

In some other embodiments, each beam ID of one or both of the first set of beam IDs and the second set of beam IDs is associated with a downlink reference signal ID (DL-RS ID) which includes one or more of one or both of a channel state information reference signal (CSI-RS) resource index and a CSI-RS resource set ID and one or both of a synchronization signal block resource indicator (SSBRI) and an SSB resource set ID.

In some embodiments, one or both of the first request includes the one or more beam IDs and the first request requests to one or more of the WD to be configured with the one or more beams a predetermined configuration frequency, transmit correlations to other beams, and transmit the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the method further includes one or both of receiving a second request for a beam ID configuration and transmitting an indication indicating at least the one or more beam IDs.

In some embodiments, one or both of: (A) causing the artificial intelligence model to be trained using the transmitted assistance information includes one or more of: (a) the WD training the artificial intelligence model; (b) the WD transmitting signaling to one or both of the network node and a cloud-based network node, the signaling including information about how to train the artificial intelligence model; (c) the WD including the received assistance information in the information about how to train the artificial intelligence model; (d) the network node training the artificial intelligence model and transmitting the trained artificial intelligence model to the WD; (e) causing the cloud-based network node to train the artificial intelligence model and to transmit the trained artificial intelligence model to the WD; and (B) performing the one or more actions includes one or more of: (a) receiving, from the WD, a third request requesting additional assistance information for a third set of beam IDs, the third set of beam IDs being part of the training data; and (b) transmitting, to the WD, the additional assistance information for the WD to delete information related to the third set of beam IDs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example SSB beam selection as part of an initial access procedure according to a P1 scenario;

FIG. 2 shows an example of CSI-RS Tx beam selection in Downlink according to a P2 scenario;

FIG. 3 shows an example of WD Rx beam selection for a corresponding CSI-RS Tx beam in downlink according to a P3 scenario;

FIG. 4 shows an example of a Set B that is a subset of Set A;

FIG. 5 shows an example of a Set A that is a set of narrow beams and a Set B that is a set of wide beams.

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of an example process in a wireless device according to some embodiments of the present disclosure;

FIG. 14 is a flowchart of an example process in a wireless device according to some embodiments of the present disclosure;

FIG. 15 is a flowchart of an example process in a network node according to some embodiments of the present disclosure;

FIG. 16 is a flowchart of an example process where a WD request assistance information to a network node according to some embodiments of the present disclosure;

FIG. 17 shows example of training samples and noised samples (Xnoise) according to some embodiments of the present disclosure;

FIG. 18 shows example mean errors corresponding to beam predictions according to some embodiments of the present disclosure;

FIG. 19 shows an example coefficient according to some embodiments of the present disclosure;

FIG. 20 shows another example coefficient according to some embodiments of the present disclosure; and

FIG. 21 shows an example correlation of beam IDs according to some embodiments of the present disclosure.

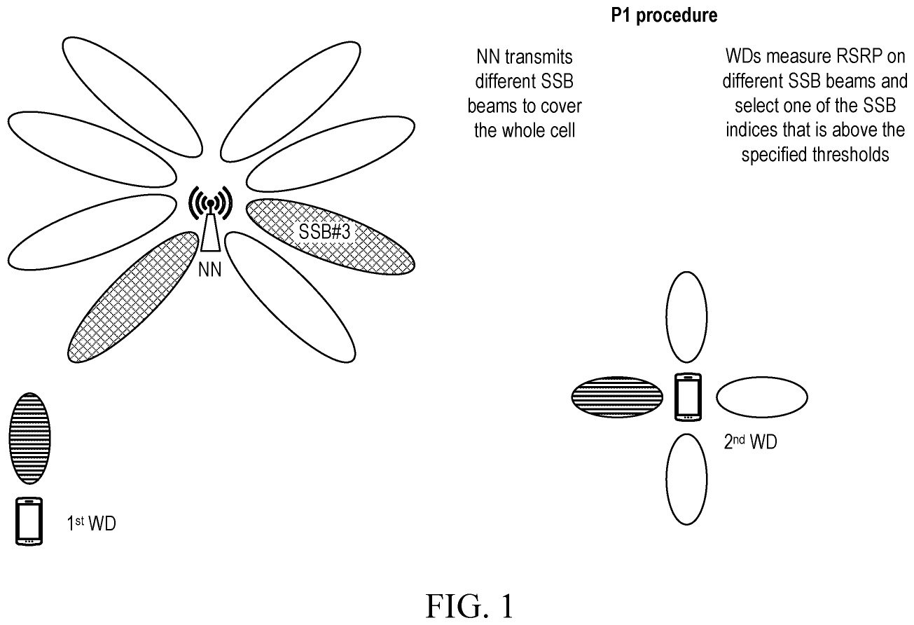

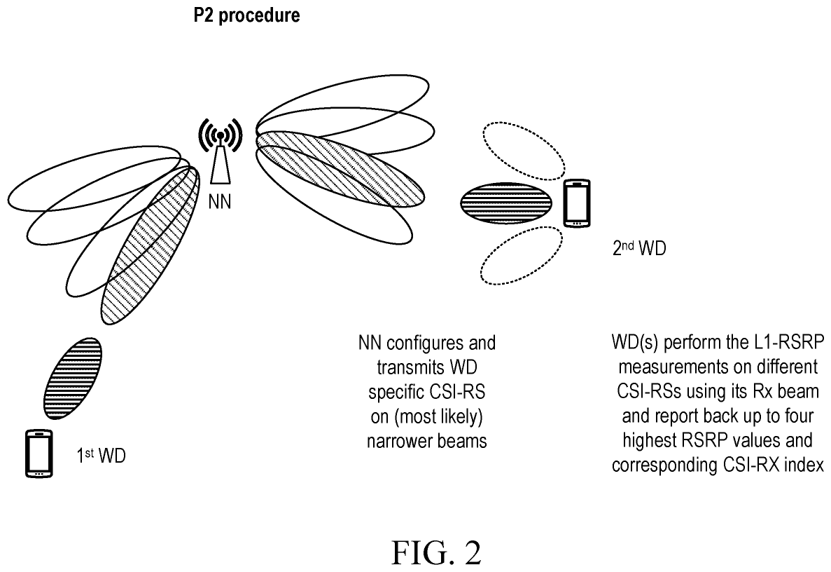

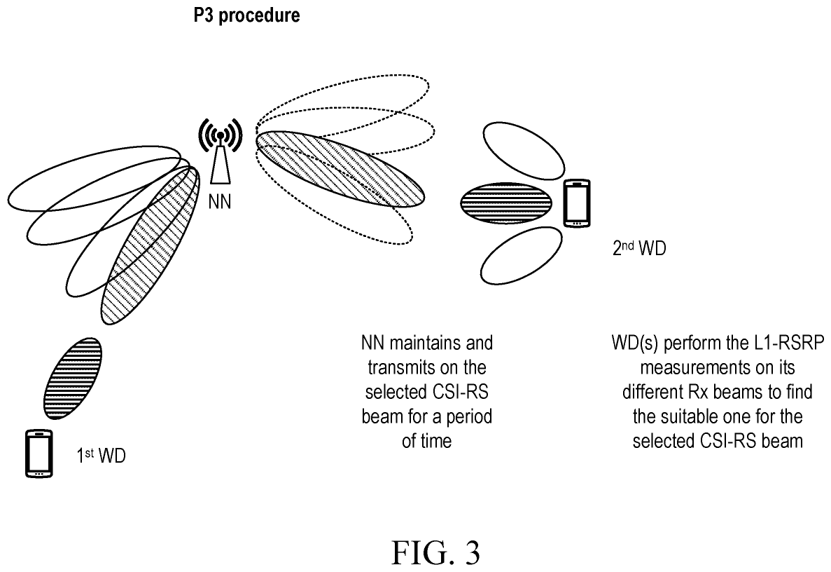

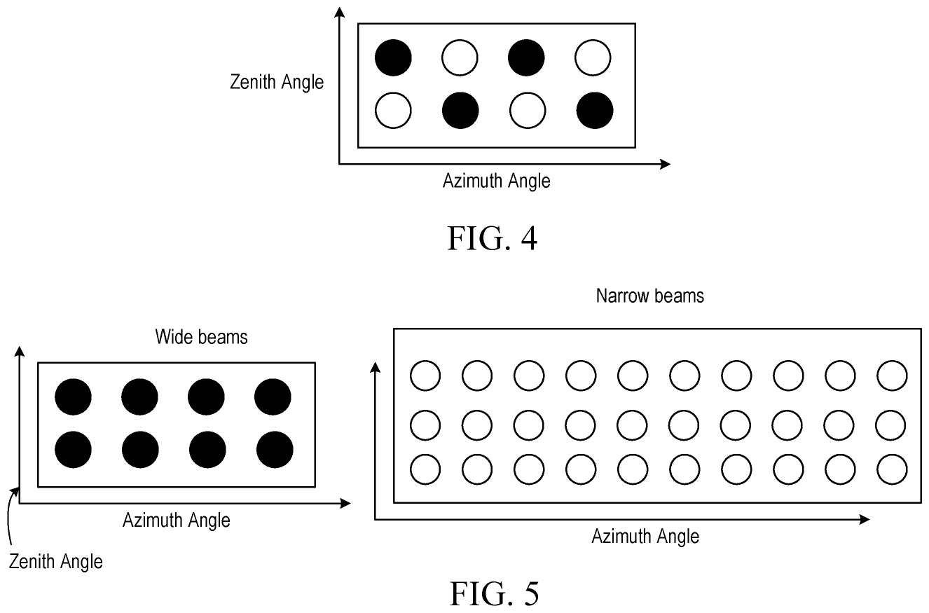

### DETAILED DESCRIPTION

Before describing in detail example embodiments, it is noted that the embodiments reside primarily in combinations of apparatus components and processing steps related to beam prediction procedures (e.g., WD beam prediction procedures) such as based on beam IDs. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

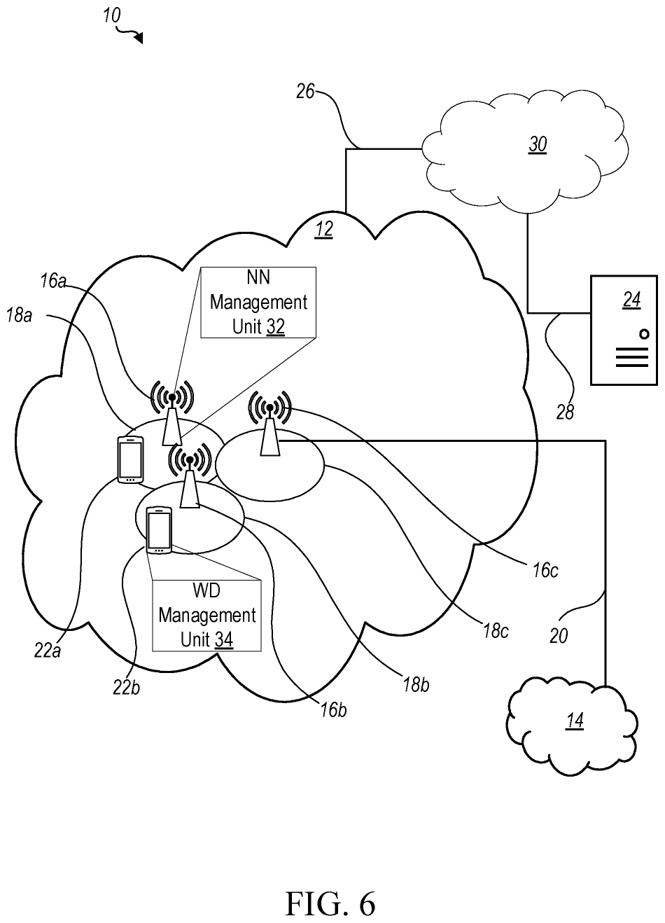

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., determine the assistance information, the determined assistance information including an indication indicating how at least one beam identifier of the first set of beam identifiers relates to a second set of beam identifiers for which the WD 22 has at least one of data and trained models. A wireless device 22 is configured to include a WD management unit 34 which is configured to receive the assistance information from the network node, where the received assistance information includes an indication indicating how at least one beam identifier of the first set of beam identifiers relates to a second set of beam identifiers for which the WD 22 has at least one of data and trained models; and/or perform a training of at least one model based at least in part on the indication.

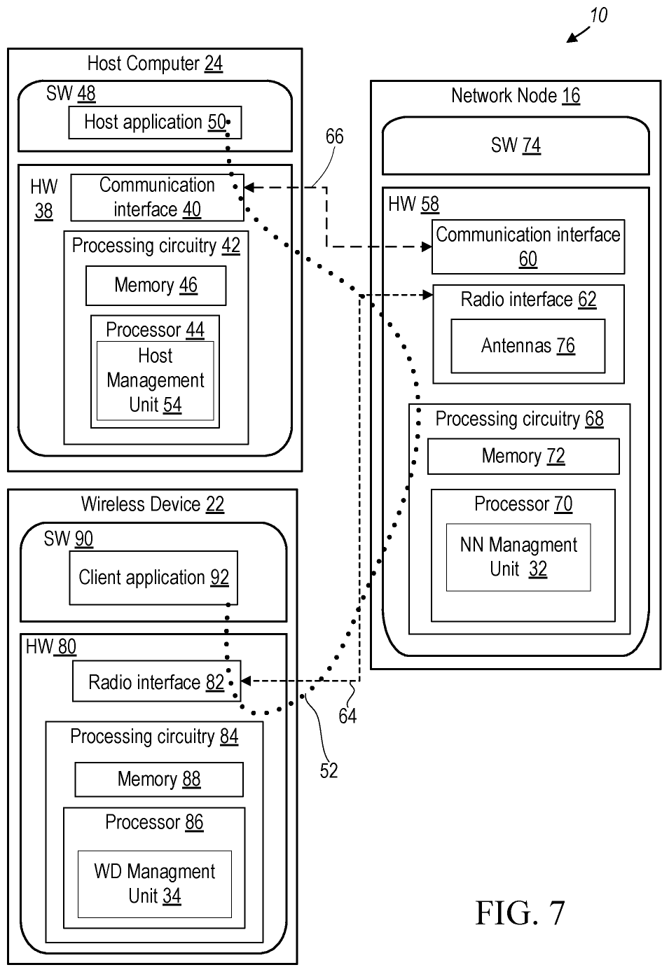

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host unit 54 configured to enable the service provider to perform any step and/or task and/or process and/or method and/or feature described in the present disclosure, e.g., observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 configured to perform any step and/or task and/or process and/or method and/or feature described in the present disclosure, e.g., determine the assistance information, the determined assistance information including an indication indicating how at least one beam identifier of the first set of beam identifiers relates to a second set of beam identifiers for which the WD 22 has at least one of data and trained models.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to receive the assistance information from the network node, where the received assistance information includes an indication indicating how at least one beam identifier of the first set of beam identifiers relates to a second set of beam identifiers for which the WD 22 has at least one of data and trained models; and/or perform a training of at least one model based at least in part on the indication.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

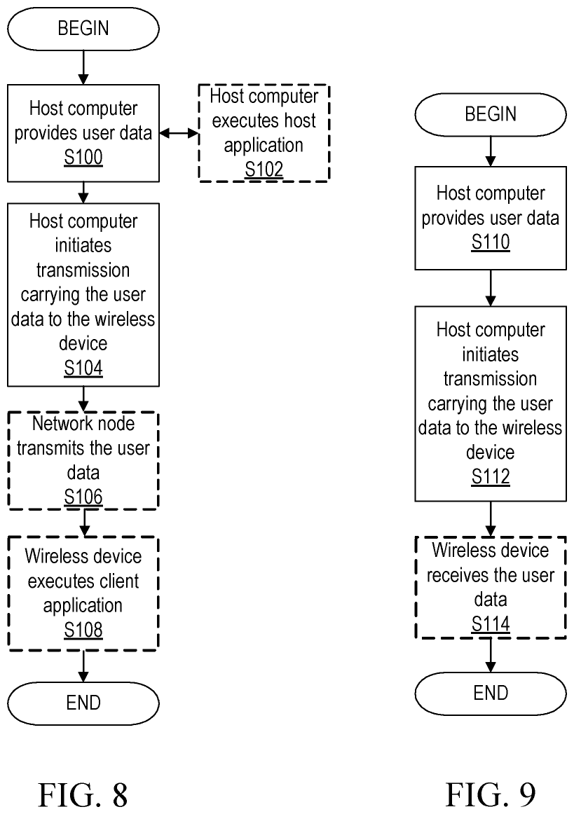

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

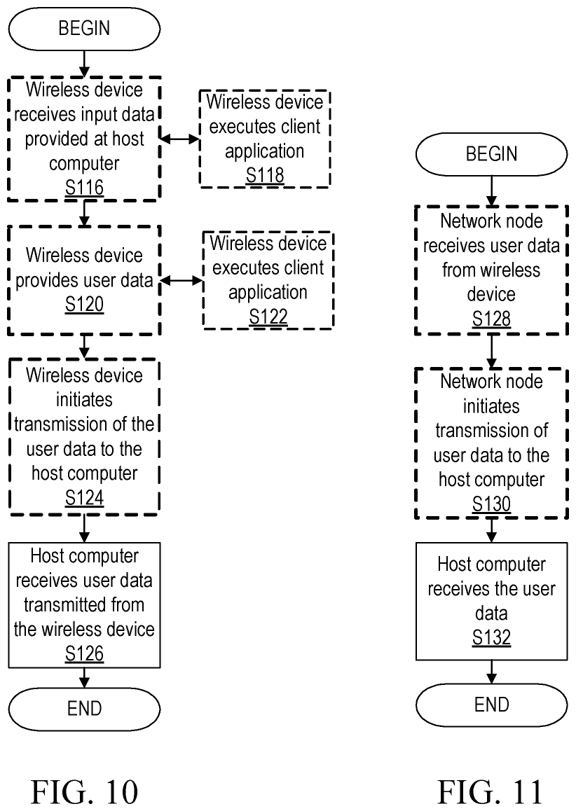

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

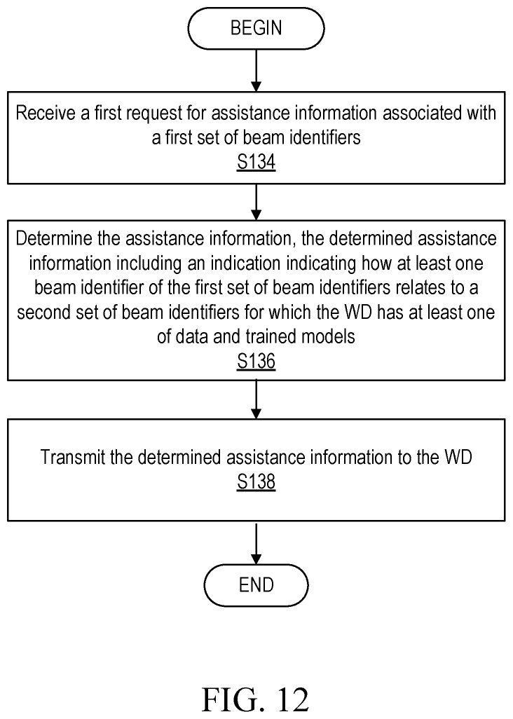

FIG. 12 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to receive (Block S134) a first request for assistance information associated with a first set of beam identifiers; determine (Block S136) the assistance information, the determined assistance information including an indication indicating how at least one beam identifier of the first set of beam identifiers relates to a second set of beam identifiers for which the WD 22 has at least one of data and trained models; and transmit (Block S138) the determined assistance information to the WD 22.

In some embodiments, the transmitted assistance information triggers the WD 22 to perform a training of at least one model based at least in part on the indication.

In some other embodiments, the method further includes receiving a second request for additional assistance information associated with a third set of beam identifiers; and transmitting the additional assistance information. The transmitted additional assistance information triggers the WD 22 to delete information related to at least one beam identifier of the third set of beam identifiers.

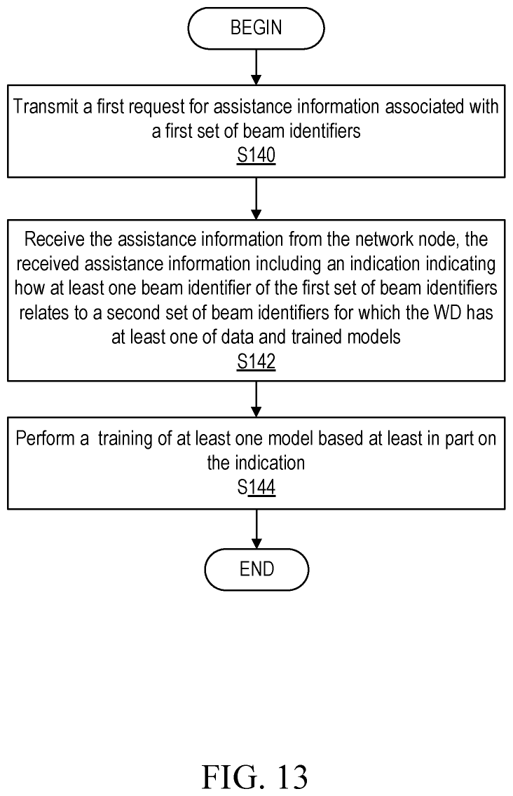

FIG. 13 is a flowchart of an example process in a wireless device 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to transmit (Block S140) a first request for assistance information associated with a first set of beam identifiers; receive (Block S142) the assistance information from the network node, the received assistance information including an indication indicating how at least one beam identifier of the first set of beam identifiers relates to a second set of beam identifiers for which the WD has at least one of data and trained models; and perform (S144) a training of at least one model based at least in part on the indication.

In some embodiments, the method further includes transmitting a second request for additional assistance information associated with a third set of beam identifiers; and receiving the additional assistance information. The transmitted additional assistance information includes another indication usable to delete information related to at least one beam identifier of the third set of beam identifiers.

In some other embodiments, the method further includes deleting the information related to the at least one beam identifier of the third set of beam identifiers, the deleted information including outdated information.

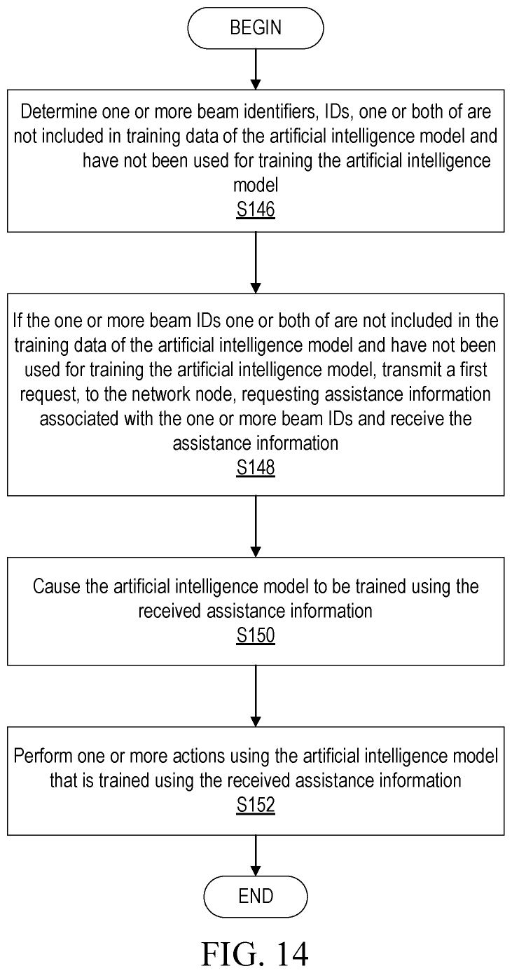

FIG. 14 is a flowchart of an example process in a WD 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. WD 22 such as via processing circuitry 84 and/or processor 86 and/or radio interface 82 is configured to communicate with a network node 16 and predict, using an artificial intelligence model, a first set of beams by measuring a second set of beams. More specifically, the WD 22 is configured to determine (Block S146) one or more beam identifiers (IDs) one or both of are not included in training data of the artificial intelligence model and have not been used for training the artificial intelligence model. The WD 22 is also configured to, if the one or more beam IDs one or both of are not included in the training data of the artificial intelligence model and have not been used for training the artificial intelligence model, transmit (Block S148) a first request, to the network node 16, requesting assistance information associated with the one or more beam IDs and receive the assistance information. In addition, the WD 22 is configured to cause (Block S150) the artificial intelligence model to be trained using the received assistance information and perform (Block S152) one or more actions using the artificial intelligence model that is trained using the received assistance information.

In some embodiments, the method further includes receiving, from the network node 16, a first set of beam IDs corresponding to the first set of beams and a second set of beam IDs corresponding to the second set of beams. The one or more beam IDs being included in one or both of the first set of beam IDs and the second set of beam IDs.

In some other embodiments, each beam ID of one or both of the first set of beam IDs and the second set of beam IDs is associated with a downlink reference signal ID (DL-RS ID). The DL-RS ID includes one or more of: (A) one or both of a channel state information reference signal, CSI-RS, resource index and a CSI-RS resource set ID; and (B) one or both of a synchronization signal block resource indicator (SSBRI) and an SSB resource set ID.

In some embodiments, one or both of the first request includes the one or more beam IDs and the first request requests to one or more of be configured with the one or more beams a predetermined configuration frequency, receive correlations to other beams, and receive the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the method further includes one or more of transmitting a second request for a beam ID configuration, receiving an indication indicating at least the one or more beam IDs, and determining whether the artificial intelligence model is valid for the one or more beam IDs.

In some embodiments, one or both of: (A) causing the artificial intelligence model to be trained using the received assistance information includes one or more of: (a) the WD 22 training the artificial intelligence model; (b) the WD 22 transmitting signaling to one or both of the network node 16 and a cloud-based network node 16, where the signaling includes information about how to train the artificial intelligence model; (c) the WD 22 including the received assistance information in the information about how to train the artificial intelligence model; (d) the network node 16 training the artificial intelligence model and transmitting the trained artificial intelligence model to the WD 22; (e) causing the cloud-based network node 16 to train the artificial intelligence model and to transmit the trained artificial intelligence model to the WD 22; and (B) performing the one or more actions includes one or more of: (a) predicting the first set of beams by measuring the second set of beams using the artificial intelligence model that is trained using the received assistance information; (b) transmitting, to the network node 16, a third request requesting additional assistance information for a third set of beam IDs, the third set of beam IDs being part of the training data; (c) receiving, from the network node 16, the additional assistance information; and (d) deleting information related to the third set of beam IDs.

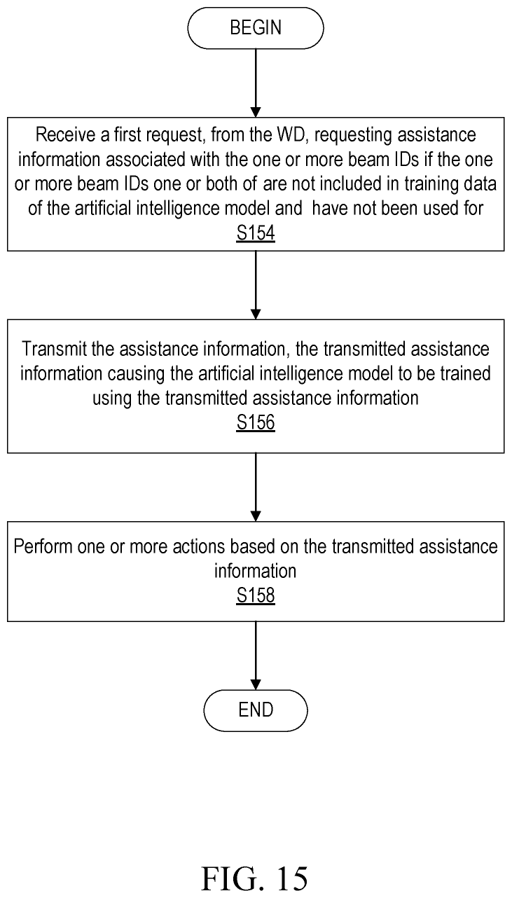

FIG. 15 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to communicate with a WD 22 and to provide assistance information usable to predict, using an artificial intelligence model, a first set of beams by measuring a second set of beams. More specifically, the network node 16 is configured to receive (Block S154) a first request, from the WD 22, requesting assistance information associated with the one or more beam IDs if the one or more beam IDs one or both of are not included in training data of the artificial intelligence model and have not been used for training the artificial intelligence model. Further, the network node 16 is configured to transmit (Block S156) the assistance information, the transmitted assistance information causing the artificial intelligence model to be trained using the transmitted assistance information and (Block S158) perform one or more actions based on the transmitted assistance information.

In some embodiments, the method further includes transmitting, to the WD 22, a first set of beam IDs corresponding to the first set of beams and a second set of beam IDs corresponding to the second set of beams, where the one or more beam IDs are included in one or both of the first set of beam IDs and the second set of beam IDs.

In some other embodiments, each beam ID of one or both of the first set of beam IDs and the second set of beam IDs is associated with a downlink reference signal ID (DL-RS ID) which includes one or more of one or both of a channel state information reference signal (CSI-RS) resource index and a CSI-RS resource set ID and one or both of a synchronization signal block resource indicator (SSBRI) and an SSB resource set ID.

In some embodiments, one or both of the first request includes the one or more beam IDs and the first request requests to one or more of the WD 22 to be configured with the one or more beams a predetermined configuration frequency, transmit correlations to other beams, and transmit the artificial intelligence model capable of describing a relation to the other beams.

In some other embodiments, the assistance information includes additional transmissions of one or more of synchronization signal blocks SSBs, channel state information reference signals (CSI-RSs) and additional beam IDs not included in the training data of the artificial intelligence model and not used for training the artificial intelligence model.

In some embodiments, the assistance information includes information about a statistical relationship between the one or more beam IDs and one or more existing beam IDs.

In some other embodiments, the assistance information includes information about a geometric relationship between the one or more beam IDs and one or more existing beam IDs.

In some embodiments, the assistance information includes one or both of information about a relationship between the one or more beam IDs and beams included in the training data of the artificial intelligence model and information about a relation between a first beam ID and a second beam ID of the one or more beam IDs.

In some other embodiments, the method further includes one or both of receiving a second request for a beam ID configuration and transmitting an indication indicating at least the one or more beam IDs.

In some embodiments, one or both of: (A) causing the artificial intelligence model to be trained using the transmitted assistance information includes one or more of: (a) the WD 22 training the artificial intelligence model; (b) the WD 22 transmitting signaling to one or both of the network node 16 and a cloud-based network node 16, the signaling including information about how to train the artificial intelligence model; (c) the WD 22 including the received assistance information in the information about how to train the artificial intelligence model; (d) the network node 16 training the artificial intelligence model and transmitting the trained artificial intelligence model to the WD 22; (e) causing the cloud-based network node 16 to train the artificial intelligence model and to transmit the trained artificial intelligence model to the WD 22; and (B) performing the one or more actions includes one or more of: (a) receiving, from the WD 22, a third request requesting additional assistance information for a third set of beam IDs, the third set of beam IDs being part of the training data; and (b) transmitting, to the WD 22, the additional assistance information for the WD 22 to delete information related to the third set of beam IDs.

Having described the general process flow of arrangements of the disclosure and having provided examples of hardware and software arrangements for implementing the processes and functions of the disclosure, the sections below provide details and examples of arrangements for performing beam prediction procedures (e.g., WD beam prediction procedures) such as based on beam IDs.

In some embodiments, the term “new beam(s)” is used to denote a beam ID that was not used, e.g., when the WD 22 collected data for training AI/ML models capable of predicting a certain combination of measured/predicted beams. An old beam may be used to describe a beam part of the WD training data. An outdated beam may refer to a beam part of the WD collected data, e.g., that is no longer transmitted from the network node 16.

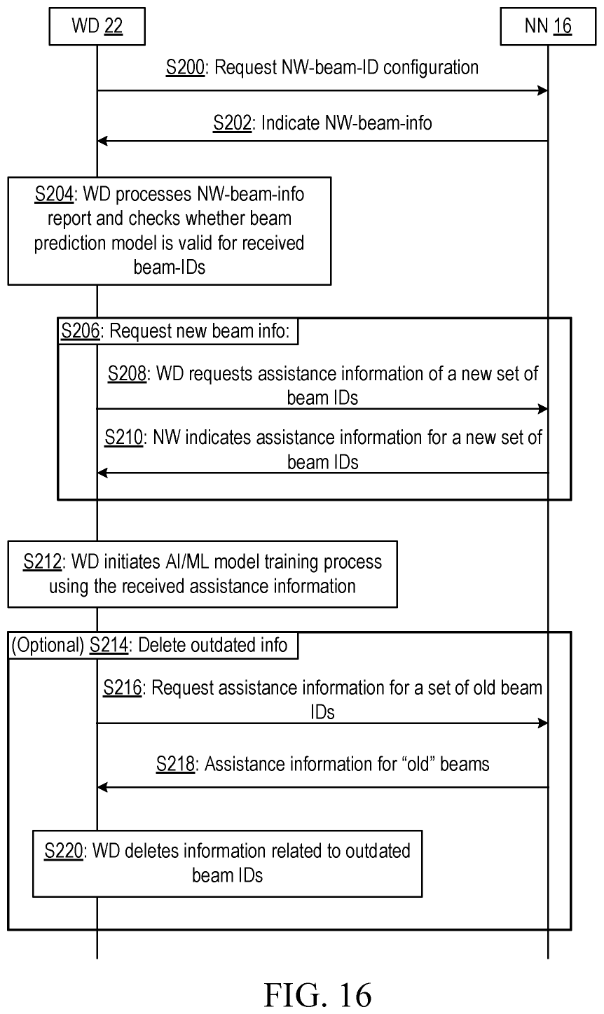

FIG. 16 shows an example process where a WD 22 requests assistance information from the network node 16. At step S200, WD 22 sends a request for network-beam-ID configuration, and at step S202, network node 16 transmit an indication of network-beam-information. At step S04, the WD 22 processes the network-beam-information (e.g., network-beam-information report) and/or checks whether a beam prediction model is valid for received beam IDs. At step S206, new beam information is requested. Step S206 may include steps S208 and S210. At step S208, the WD 22 requests assistance information assistance information of a new set of beam IDs, and at step S210, the network node 16 indicates assistance information for the new set of beam IDs. At step, S212, WD 22 initiates an AI/ML model training process, e.g., using the received assistance information. At step S214, outdated information may be deleted. Step S214 may include steps S216, S218, and/or S220. At step S216, WD 22 may request assistance information for a set of old beam IDs. At step S218, network node 16 may transmit assistance information for old beams. At step S220, WD 22 may further delete information related to outdated beam IDs.

In some embodiments, one or more of the following may be performed:
The network node 16 may be configured to associate unique beam IDs to different SSB/CSI-RS beams, e.g., using proprietary methods. For example, the network node 16 may be configured to maintain a beam ID-to-beam table that associates different beam IDs with different precoding weights for SSBs/CSI-RSs.
The beam IDs associated with different SSB/CSI-RS beams may be made available to the WD 22 whenever the WD 22 measures the corresponding RSs. For example, the beam IDs can be signaled explicitly as part of a CSI report configuration, broadcast as part of initial access, and/or signaled implicitly via an enhanced TCI state.
The WD 22 may be configured to assume that all measurements (e.g., L1-RSRPs) associated with a particular beam ID are compatible with one another. For example, the WD 22 can assume that all SSB/CSI-RS with same beam ID are precoded in the same way.
The network node 16 may be configured to define a new beam ID whenever it requires a new precoder for SSB/CSI-RS that is sufficiently different all existing the existing SSB/CSI-RS precoders (e.g., entries in the beam ID-to-beam table).
When the WD 22 encounters a new beam ID (e.g., a beam ID for which it has not collected data and/or trained AI/ML models), then WD 22 may request additional assistance information from the network node 16. Examples of such assistance information include the following:
Additional or more frequent transmissions of the corresponding SSB/CSI-RS (e.g., to enable the WD 22 to collect training data for the new beam ID).
Information about statistical relationships between the new beam ID and one-or-more of the existing beam IDs (e.g., the NW signals correlation matrix describing how L1-RSRP measurements correlate with the L1-RSRPs of existing beam IDs obtained from, for example, legacy CSI reports).
Information about the geometric relationship between the new beam ID and one-or-more of the existing beam IDs (e.g., the closest beam IDs with respect to a defined metric such as cosine similarity between the precoders).
Assist WD 22 with detailed information on relation of new vs old beam IDs (e.g., captured using an ML model).

As described above, WD 22 may be configured to use such information to update WD-side datasets and/or train/retrain AI/ML models and/or to delete models or data that use outdated beam information.

### Example WD Beam Prediction Model

A beam prediction model may include predicting a set of beams based on measurements on another set of beams. This could be done by training a number of models each capable of handling a certain combination of predicted vs measured beams. For example, a beam prediction model f1 uses RSRP measurements on beam ID (1, 2, 3) to predict beam ID 4, f2 uses RSRP measurements on beam ID (1, 3, 4) to predict beam ID 2, etc.

Another example, e.g., requiring only a single model, is a denoising autoencoder (DAE), where a WD 22 could train a DAE for relaxing the WD required measurements on its CSI-RS or SSB-beams. WD 22 may first collect a set of measurements comprising RSRP data for all beams. Next, WD 22 may perform noising of the measurements, e.g., creates a pattern where one of the beams can be omitted/predicted.

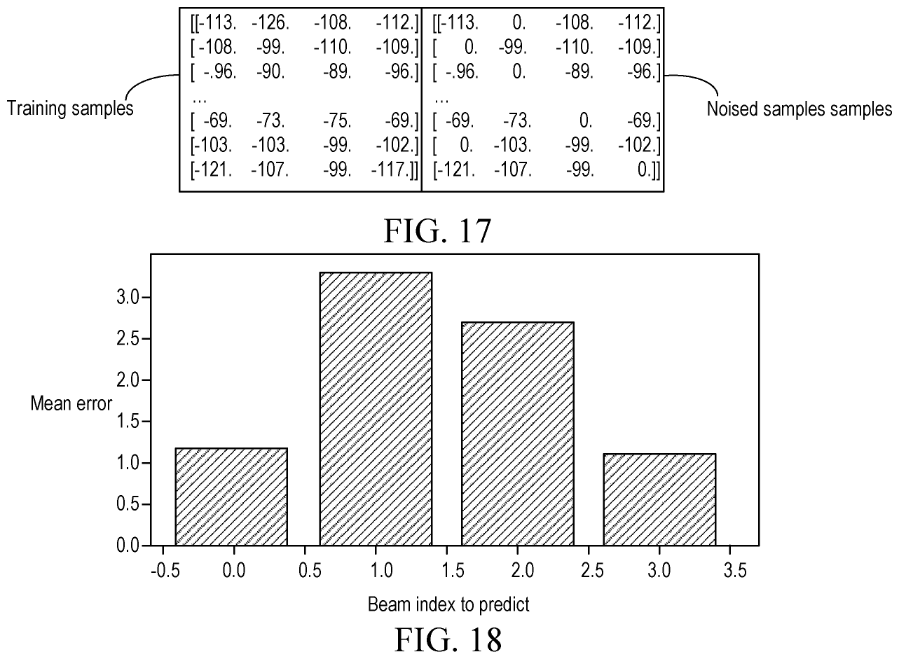

In one example, a dense urban scenario with a macro transmitted 4 beams is used to generate an example dataset. FIG. 17 shows example training samples x and noised samples (Xnoise). The noised samples in the dataset are retrieved after applying four different noising patterns ([0, 1, 1, 1], [1, 0, 1, 1], [1, 1, 0, 1], [1, 1, 1, 0]). WD 22 may be configured to build a model F able to predict the actual values from the noised samples, F(xnoise)->x, comprising a 3-layered feedforward neural network with 8 nodes in each layer. Further, WD 22 can evaluate the reconstruction performance when omitting a certain beam. An example of the average error when predicting a certain beam is shown in FIG. 18. The results show how the model is able to reconstruct beam 3, below 1.5 dB mean error using measurements on beam 0, 1, 2 (noising pattern [1, 1, 1, 0]). The network node 16 and/or WD 22 can change its measuring preference based on the reconstruction performance for the measured beams.

### Beam ID

The beam ID may be defined in such way that it assumes a certain configuration for the network node precoder and transmission power, enabling the device (e.g., WD, network node) to build models for predicting the effective channel for a certain beam ID (e.g., associated to an CSI-RS transmission for example).

One example of a beamforming pattern may be a base station (network node) antenna pattern with 10 beams. A network node 16 can transmit 10 beams, where each beam is configured to be strong in a certain direction. WD 22 may be configured to receive 10 different unique beam IDs.

### Beam ID Request and Assistance Information (Step S204/S208)

WD 22 may be configured to use ML to build a model and predict a first set of beams (Set A) based on measurements on a second set of beams (Set B). Network node 16 may be configured to indicate the beam IDs to be configured for the WD 22 to measure (Set B) and for the WD 22 to predict (Set A). Network node 16 can inform the WD 22 for example by broadcasting in a SIB message, or unicast transmission via RRC. For example, two lists of beam IDs can be indicated to the WD 22, a list of beam IDs for Set A (used for prediction) and a list of beam IDs for Set B (used for measurements). In one embodiment, each beam ID in the list of beam IDs is explicitly associated with a DL-RS ID. The DL-RS ID can for example consist of one or more of:
CRI, and/or CSI-RS resource set ID
SSBRI and/or SSB resource set ID

Further, WD 22 may be configured to compare if the model IDs are valid as a model input and model output. The validity can be based on the data used for training the model, e.g., if such beam IDs were present in the training data. If not, it can request assistance information for the set of beams. The request could comprise:
The beam IDs of the “new” beam(s) and/or:
   A request to be configured with such “new” beams more frequently, which may include which beam IDs relate the new measurements towards.
   A request to receive correlations to other beams, which may include which beam IDs relate the new measurements towards.
   A request to receive a model capable of explaining a relation to other beams, e.g., including which beam IDs the network node should relate the new measurements towards.

In one embodiment, a “Beam configuration tag” associated with a certain network-beam-ID configuration may be signaled to the WD 22. In some embodiments, this may be performed instead of signaling the full list(s) of beam IDs to the WD 22 (e.g., which requires overhead signaling). In case the WD 22 has a stored trained model associated with the indicated “Beam configuration tag”, the WD 22 can apply that stored trained model for future beam predictions. If the WD 22 does not have a stored trained model associated with the indicated “Beam configuration tag”, the WD 22 can send a request to the network node to attain the network-beam-ID configuration (e.g., Step 200). In one embodiment, the WD 22 can assume that a network-beam-ID configuration with a certain “Beam configuration tag” has a certain set of beam IDs in Set A (i.e., set of beams used for prediction), a certain set of beam IDs for Set B (i.e., set of beams used for measurements), and/or a certain “DL-RS ID to beam ID mapping” for respective beam ID.

### Network Assistance Information (Step S210)

The network node 16 may be configured to, e.g., upon receiving a WD request, perform one or more of the following steps:
Assist WD data collection with more frequent transmission of new beam IDs.
Assist WD 22 with granular information on relations of new vs old beam IDs (e.g., correlation matrix).
Assist WD 22 with granular information on relations of new vs outdated beam IDs (for example, a new beam might be a merge of two outdated beams, an outdated beam might be a split into two new beams, a new beam might be an outdated beam tilted a few degrees). The model may assume that the new beam and outdated beams has strong correlation and use that as input when training the model with the new set of beams.
Assist WD 22 with granular information on relations of new vs another new beam IDs (e.g., correlation matrix). This could be useful if there are new beams IDs both among the beams used for measurements (Set B) and the beams used for prediction (Set A).
Assist WD 22 with detailed information on relation of new vs old beam IDs (e.g., captured using an ML model).

### WD Data Collection Assistance

The network node 16 may configure the WD 22 with more measurements on the new beams. Also, the measurements in combination with a set of old beams could be used by the WD 22 to create a model capable of predicting the new beams based on the old beams. The assistance information (e.g., network assistance information) (Step S210) may comprise information about the extra transmissions of the new beam IDs. The WD step upon reception of assistance information may comprise storing the data associated to the new beams, creating a new model capable of predicting the said beam IDs, and/or retrain the denoising autoencoder with the new data.

Assisting WD 22 with Granular Information about Relations of New Ys Old Beam IDs (e.g., Correlation Matrix)

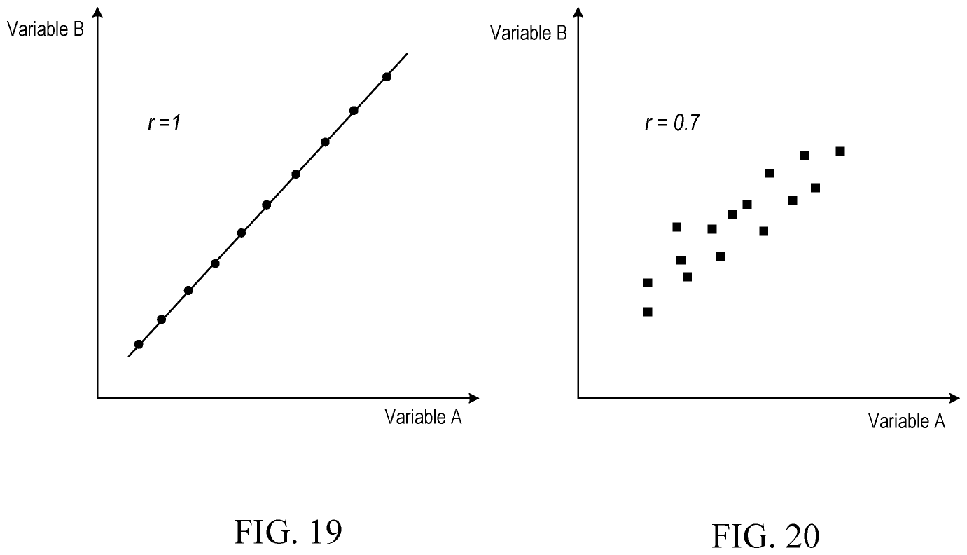

In some embodiments, WD 22 may be configured to request to receive a correlation metric for the new beams, in relation to the old beams (or in relation to other new beams and/or to outdated beams). This way, the WD 22 can, for example, know which old beams the WD 22 should relate the new beams with. The network node 16 can, for example, calculate the Pearson correlation among historical beam reports by other WDs 22. In general, a close to 1 Pearson coefficient can indicate high prediction performance when predicting the second value based on the first value or vice-versa. It also indicates that less measurements are needed to build such predictor (less need to average out noise). Two examples of the Pearson coefficient for different relations between variable A & B are shown in FIGS. 19 and 20. More specifically, the graph on FIG. 19 requires less data than the graph on FIG. 20 in order to build a predictor that predicts variable B given variable A measurements or vice versa).

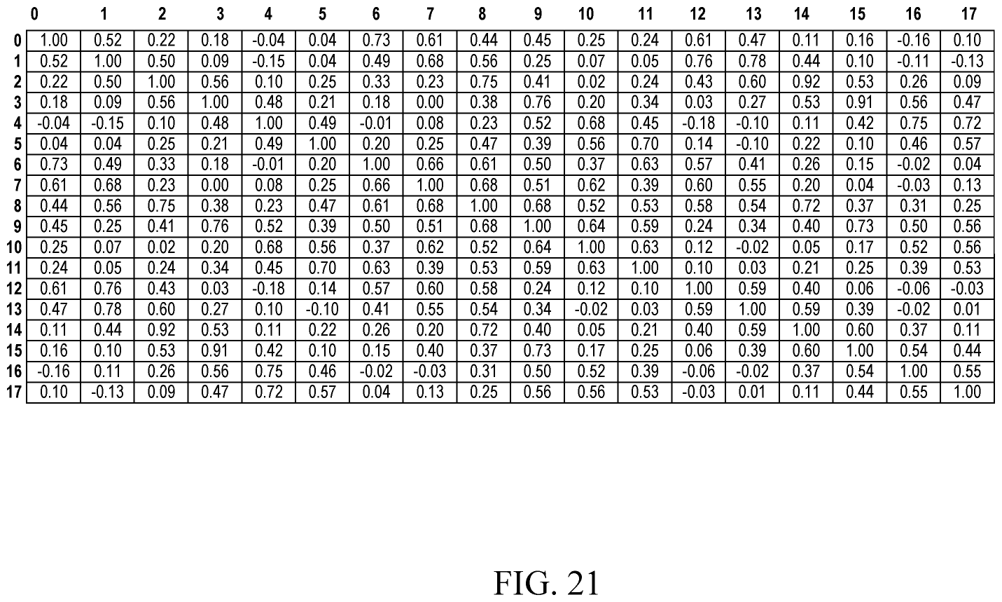

An example set of beam measurement simulation data collected (and used for FIG. 19, FIG. 20 and/or FIG. 21) from a network node 16 (e.g., base station) in a dense urban environment. Based on such collected data, FIG. 21 shows the Pearson correlation in a scenario where a network node 16 (e.g., base station) can form 18 different beams (each with a unique ID). The Pearson correlation with a positive correlation indicates that the two beams increase simultaneously. A negative correlation indicates a decrease in RSRP for a first beam in case the RSRP of the second beam is increasing.

The network assistance (e.g., step S210) could include the matrix below, or a sparse representation where all correlations above a certain reference value (optionally indicated by the WD 22) is included.

The WD step upon reception of assistance information could comprise selecting which “old” beams to use to predict the new beams. For example, in the correlation matrix, if beam-ID 17 is a new beam, the WD 22 could select old beam IDs (0-16) to predict the new beam such as selecting among those with high correlation such as beam 3, 4, 5.

Assisting WD 22 with Detailed Information on Relation of New Vs Old Beam IDs (e.g., Captured Using an ML Model) The network node 16, using data collected from UE CSI-RS/SSB beam reports can train a model that maps the old beam IDs to the new. For example, in the figure above.

Use data for beam ID 1 and 2 to predict ID 3. Network node 16 can indicate such model/function to the device. Note that a model could comprise of a simple linear regression, or more complex models such as neural networks or random forest. The WD 22 may, in one embodiment, indicate its preferred model type or provide indication of its supported models. The network node assistance information (step 240) may include the function description f.

The WD 22 method may include, upon reception of assistance information, generating new data using the collected data on “old” beams by performing model inference of the received network model with such data. With the updated dataset also including the new beam information, it can retrain set of the beam prediction model(s) again. In another embodiment, the WD 22 may be configured to use the network received model directly and update it upon collection of new data from new beam IDs.

### Handling of Outdated Beam IDs

In some embodiments, the WD 22 may be configured to request information on beams not part of the indication from network node 16, e.g., Step S202. The WD 22 can use such information to delete outdated data or models, e.g., models that inputs/outputs values associated to outdated beam IDs.

In one embodiment, an explicit indication is used to inform the WD 22 whether it can delete information related to the outdated beams, and/or whether the WD 22 should continue to store the information. For example, if the network is to be reconfigured (e.g., likely to be reconfigured) such that the outdate beams for the current beam configuration are applicable again at a later time instance, it may be useful if the WD 22 does not delete the information related to the outdated beams. In some embodiments, if the network beam configuration is permanent or the network is not likely to be using the outdated beams again, the network node 16 may indicate to the WD 22 to delete information associated with the outdated beams.

The following is a nonlimiting list of example embodiments.

Embodiment A1. A network node configured to communicate with a wireless device, WD, the network node configured to, and/or comprising a radio interface and/or comprising processing circuitry configured to:
receive a first request for assistance information associated with a first set of beam identifiers;
determine the assistance information, the determined assistance information including an indication indicating how at least one beam identifier of the first set of beam identifiers relates to a second set of beam identifiers for which the WD has at least one of data and trained models; and
transmit the determined assistance information to the WD.

Embodiment A2. The network node of Embodiment A1, wherein the transmitted assistance information triggers the WD to perform a training of at least one model based at least in part on the indication.

Embodiment A3. The network node of any one of Embodiments A1 and A2, wherein at least one of the network node and the radio interface is configured to:
receive a second request for additional assistance information associated with a third set of beam identifiers; and
transmit the additional assistance information, the transmitted additional assistance information triggering the WD to delete information related to at least one beam identifier of the third set of beam identifiers.

Embodiment B1. A method in a network node configured to communicate with a wireless device, WD, the method comprising:
receiving a first request for assistance information associated with a first set of beam identifiers;
determining the assistance information, the determined assistance information including an indication indicating how at least one beam identifier of the first set of beam identifiers relates to a second set of beam identifiers for which the WD has at least one of data and trained models; and
transmitting the determined assistance information to the WD.

Embodiment B2. The method of Embodiment B1, wherein the transmitted assistance information triggers the WD to perform a training of at least one model based at least in part on the indication.

Embodiment B3. The method of any one of Embodiments B1 and B2, wherein the method further includes:
receiving a second request for additional assistance information associated with a third set of beam identifiers; and
transmitting the additional assistance information, the transmitted additional assistance information triggering the WD to delete information related to at least one beam identifier of the third set of beam identifiers.

Embodiment C1. A wireless device, WD, configured to communicate with a network node, the WD configured to, and/or comprising a radio interface and/or processing circuitry configured to:
transmit a first request for assistance information associated with a first set of beam identifiers;
receive the assistance information from the network node, the received assistance information including an indication indicating how at least one beam identifier of the first set of beam identifiers relates to a second set of beam identifiers for which the WD has at least one of data and trained models; and perform a training of at least one model based at least in part on the indication.

Embodiment C2. The WD of Embodiment C1, wherein at least one of the WD and the radio interface is further configured to:
transmit a second request for additional assistance information associated with a third set of beam identifiers; and
receive the additional assistance information, the transmitted additional assistance information including another indication usable to delete information related to at least one beam identifier of the third set of beam identifiers.

Embodiment C3. The WD of Embodiment C2, wherein the processing circuitry is further configured to:
delete the information related to the at least one beam identifier of the third set of beam identifiers, the deleted information including outdated information.

Embodiment D1. A method in a wireless device, WD, configured to communicate with a network node, the method comprising:
transmitting a first request for assistance information associated with a first set of beam identifiers;
receiving the assistance information from the network node, the received assistance information including an indication indicating how at least one beam identifier of the first set of beam identifiers relates to a second set of beam identifiers for which the WD has at least one of data and trained models; and
perform a training of at least one model based at least in part on the indication.

Embodiment D2. The method of Embodiment D1, wherein the method further includes:
transmitting a second request for additional assistance information associated with a third set of beam identifiers; and
receiving the additional assistance information, the transmitted additional assistance information including another indication usable to delete information related to at least one beam identifier of the third set of beam identifiers.

Embodiment D3. The method of Embodiment D2, wherein the method further includes:
deleting the information related to the at least one beam identifier of the third set of beam identifiers, the deleted information including outdated information.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID Identity/identifier
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
SCS Subcarrier Spacing
SINR Signal to Interference plus Noise Ratio
SSB Synchronization Signal Block
RL Reinforcement Learning
RS Reference Signal
Rx Receiver
TB Transport Block
TDD Time-Division Duplex
TCI Transmission configuration indication
TRP Transmission/Reception Point
Tx Transmitter
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are 5 possible in light of the above teachings without departing from the scope of the following claims.

1. A wireless device, WD, configured to communicate with a network node and predict, using an artificial intelligence model, a first set of beams by measuring a second set of beams, the WD being configured to:
determine that one or more beam identifiers, IDs, one or both of:
are not included in training data of the artificial intelligence model; and
have not been used for training the artificial intelligence model;
if the one or more beam IDs one or both of are not included in the training data of the artificial intelligence model and have not been used for training the artificial intelligence model:
transmit a first request, to the network node, requesting assistance information associated with the one or more beam IDs; and
receive the assistance information;
cause the artificial intelligence model to be trained using the received assistance information; and
perform one or more actions using the artificial intelligence model that is trained using the received assistance information.

2.-10. (canceled)

11. A method in a wireless device, WD, configured to communicate with a network node and predict, using an artificial intelligence model, a first set of beams by measuring a second set of beams, the method comprising:
determining that one or more beam identifiers, IDs, one or both of:
are not included in training data of the artificial intelligence model; and
have not been used for training the artificial intelligence model;
if the one or more beam IDs one or both of are not included in the training data of the artificial intelligence model and have not been used for training the artificial intelligence model:
transmitting a first request, to the network node, requesting assistance information associated with the one or more beam IDs;
receiving the assistance information;
cause the artificial intelligence model to be trained using the received assistance information; and
perform one or more actions using the artificial intelligence model that is trained using the received assistance information.

12. The method of claim 11, wherein the method further includes:
receiving, from the network node, a first set of beam IDs corresponding to the first set of beams and a second set of beam IDs corresponding to the second set of beams, the one or more beam IDs being included in one or both of the first set of beam IDs and the second set of beam IDs.

13. The method of claim 12, wherein each beam ID of one or both of the first set of beam IDs and the second set of beam IDs is associated with a downlink reference signal ID, DL-RS ID, the DL-RS ID including one or more of:
one or both of a channel state information reference signal, CSI-RS, resource index and a CSI-RS resource set ID; and
one or both of a synchronization signal block resource indicator, SSBRI, and an SSB resource set ID.

14. The method of claim 11, wherein one or both of:
the first request includes the one or more beam IDs; and
the first request requests to one or more of:
be configured with the one or more beams a predetermined configuration frequency;
receive correlations to other beams; and
receive the artificial intelligence model capable of describing a relation to the other beams.

15. The method of claim 11, wherein the assistance information includes:
additional transmissions of one or more of synchronization signal blocks SSBs, channel state information reference signals, CSI-RSs, and additional beam IDs not included in the training data of the artificial intelligence model and not used for training the artificial intelligence model.

16. The method of claim 11, wherein the assistance information includes:
information about a statistical relationship between the one or more beam IDs and one or more existing beam IDs.

17. The method of claim 11, wherein the assistance information includes:
information about a geometric relationship between the one or more beam IDs and one or more existing beam IDs.

18. The method of claim 11, wherein the assistance information includes one or both of:
information about a relationship between the one or more beam IDs and beams included in the training data of the artificial intelligence model; and
information about a relation between a first beam ID and a second beam ID of the one or more beam IDs.

19. The method of claim 11, wherein the method further includes one or more of:
transmitting a second request for a beam ID configuration;
receiving an indication indicating at least the one or more beam IDs; and
determining whether the artificial intelligence model is valid for the one or more beam IDs.

20. The method of claim 11, wherein one or both of:
causing the artificial intelligence model to be trained using the received assistance information includes one or more of:
the WD training the artificial intelligence model;
the WD transmitting signaling to one or both of the network node and a cloud-based network node, the signaling including information about how to train the artificial intelligence model;
the WD including the received assistance information in the information about how to train the artificial intelligence model;
the network node training the artificial intelligence model and transmitting the trained artificial intelligence model to the WD;
causing the cloud-based network node to train the artificial intelligence model and to transmit the trained artificial intelligence model to the WD; and
performing the one or more actions includes one or more of:
predicting the first set of beams by measuring the second set of beams using the artificial intelligence model that is trained using the received assistance information;
transmitting, to the network node, a third request requesting additional assistance information for a third set of beam IDs, the third set of beam IDs being part of the training data;
receiving, from the network node, the additional assistance information; and
deleting information related to the third set of beam IDs.

21. A network node configured to communicate with a wireless device, WD, and to provide assistance information usable to predict, using an artificial intelligence model, a first set of beams by measuring a second set of beams, the network node being configured to:
receive a first request, from the WD, requesting assistance information associated with the one or more beam IDs if the one or more beam IDs one or both of:
are not included in training data of the artificial intelligence model; and
have not been used for training the artificial intelligence model;
transmit the assistance information, the transmitted assistance information causing the artificial intelligence model to be trained using the transmitted assistance information; and
perform one or more actions based on the transmitted assistance information.

22.-30. (canceled)

31. A method in a network node configured to communicate with a wireless device, WD, and to provide assistance information usable to predict, using an artificial intelligence model, a first set of beams by measuring a second set of beams, the method comprising:
receiving a first request, from the WD, requesting assistance information associated with the one or more beam IDs if the one or more beam IDs one or both of:
are not included in training data of the artificial intelligence model; and
have not been used for training the artificial intelligence model;
transmitting the assistance information, the transmitted assistance information causing the artificial intelligence model to be trained using the transmitted assistance information; and
performing one or more actions based on the transmitted assistance information.

32. The method of claim 31, wherein the method further includes:
transmitting, to the WD, a first set of beam IDs corresponding to the first set of beams and a second set of beam IDs corresponding to the second set of beams, the one or more beam IDs being included in one or both of the first set of beam IDs and the second set of beam IDs.

33. The method of claim 32, wherein each beam ID of one or both of the first set of beam IDs and the second set of beam IDs is associated with a downlink reference signal ID, DL-RS ID, the DL-RS ID including one or more of:
one or both of a channel state information reference signal, CSI-RS, resource index and a CSI-RS resource set ID; and
one or both of a synchronization signal block resource indicator, SSBRI, and an SSB resource set ID.

34. The method of claim 31, wherein one or both of:
the first request includes the one or more beam IDs; and
the first request requests to one or more of:
the WD to be configured with the one or more beams a predetermined configuration frequency;
transmit correlations to other beams; and
transmit the artificial intelligence model capable of describing a relation to the other beams.

35. The method of claim 31, wherein the assistance information includes:
additional transmissions of one or more of synchronization signal blocks SSBs, channel state information reference signals, CSI-RSs, and additional beam IDs not included in the training data of the artificial intelligence model and not used for training the artificial intelligence model.

36. The method of claim 31, wherein the assistance information includes:
information about a statistical relationship between the one or more beam IDs and one or more existing beam IDs.

37. The method of claim 31, wherein the assistance information includes:
information about a geometric relationship between the one or more beam IDs and one or more existing beam IDs.

38. The method of claim 31, wherein the assistance information includes one or both of:
information about a relationship between the one or more beam IDs and beams included in the training data of the artificial intelligence model; and
information about a relation between a first beam ID and a second beam ID of the one or more beam IDs.

39. (canceled)

40. (canceled)
